(19) United States
(12) Patent Application Publication
(10) Pub. No.: US 2025/0012136 A1
(43) Pub. Date: Jan. 9, 2025

(54) A WINDOW ASSEMBLY, A METHOD FOR ASSEMBLING A WINDOW ASSEMBLY AND USE OF A WINDOW ASSEMBLY

(71) Applicant: SIMPLYDAYLIGHT A/S, Aarhus C (DK)

(72) Inventor: Poul Søgaard NIELSEN, Vejle 0 (DK)

(73) Assignee: SIMPLYDAYLIGHT A/S, Aarhus C (DK)

(21) Appl. No.: 18/710,895

(22) PCT Filed: Nov. 18, 2022
(86) PCT No.: PCT/DK2022/050242

§ 371 Date: May 16, 2024

(30) Foreign Application Priority Data
Nov. 19, 2021 (DK) PA 2021 70572

(51) Int. Cl. E06B 3/56; E06B 3/66

(52) U.S. Cl. CPC E06B 3/56; E06B 3/6621

(57) ABSTRACT

Disclosed is a window assembly (1) comprising a windowpane (2), a window frame (3) extending along a periphery of one side of the windowpane (2), and a connecting strip (4) arranged between the window frame (3) and the windowpane (2). The connecting strip (4) is adhered to the windowpane (2) by means of an adhesive (5) and the connecting strip (4) is connected to the window frame (3) by means of mechanical connection means (6) extending through through-holes (9) in the connecting strip (4). A method for assembling a window assembly (1) and use of a window assembly (1) are also disclosed.

### FIELD OF THE INVENTION

The invention relates to a window assembly comprising a windowpane and a window frame extending along a periphery of one side of the windowpane. The invention further relates to a method for assembling a window assembly and use of a window assembly.

### BACKGROUND OF THE INVENTION

More simple window designs that are more environmentally friendly, easier to manufacture, lighter, have higher insulating power and are more inexpensive are in high demand. Especially if they also can be designed more esthetically pleasing.

All-glass façade windows—i.e., frameless windows where the external face is made only of the outer glass panel of the windowpane—are therefore desired, in that the all-glass façade will eliminate thermal bridges, they are more durable and more or less maintenance-free, easier to manufacture etc.

Thus, from the European patent EP 1 706 569 B1 it is therefore known to form a building facade from pultruded glass fiber reinforced polyester bodies connected to a glass panel by means of adhesive so that the bodies form an inner support structure arranged to be connected to other inner support structures and carry the glass panels. However, such bodies are expensive and complex to manufacture.

And from the German patent application DE 3832178 A1 it is known to connect a profile to the inner side of a windowpane by means of adhesive and then connected the profile to a frame structure by means of pins or ribs formed integrally with the profile. However, particularly the profile used in this system is complex and expensive.

It is therefore an object of the present invention to provide for a cost-efficient technique of forming a window assembly.

### THE INVENTION

The invention provides for a window assembly comprising a windowpane, a window frame extending along a periphery of one side of the windowpane, and a connecting strip arranged between the window frame and the windowpane. The connecting strip is adhered to the windowpane by means of an adhesive and the connecting strip is connected to the window frame by means of mechanical connection means extending through through-holes in the connecting strip.

Forming a strong adhering connection against the inside surface of the windowpane requires that the material being adhered to the windowpane has a coefficient of thermal expansion similar to that of glass. Thus, it is not possible to form a strong connection if e.g. a wood frame is adhered directly to the windowpane. However, by bridging the window frame and the windowpane by means of a connecting strip it is possible to provide the connecting strip with qualities-particularly regarding coefficient of thermal expansion-making it possible to form a strong adhesion between the windowpane and the connecting strip. And by connecting the connecting strip to the window frame by means of mechanical connection means it is possible to form the window frame in a material having qualities that are not limited to a narrow specific coefficient of thermal expansion range. I.e., it is possible to form the window frame in a material that is more environmentally friendly, less expensive, easier to manufacture or machine, having better insulating properties and/or other. Furthermore, connecting the connecting strip to the window frame by means of mechanical connection means extending through through-holes in the connecting strip is advantageous in that this ensures a simple, strong, and durable connection between the connecting strip and the window frame which enables that the connecting strip is easy to manufacture and assemble.

In this context the term “one side of the windowpane” should be understood as one of the two major sides of a windowpane (typically the inner side of the windowpane) i.e. the side of the windowpane opposite to the exterior all-glass façade outer face of the window assembly. I.e. given the two-dimensional nature of a windowpane the sides referred to throughout this document are the large glass surfaces forming the interior and exterior face of the windowpane.

Also, in this context the term “window frame” should be understood as the load-carrying structure by means of which the window assembly is connected to the surrounding structure—i.e. to the surrounding wall of a building, to a neighboring window assembly or other.

Furthermore, in this context the term “strip” should be understood as any kind of minor moulding, fillet, profile or other designed to bridge and connect the windowpane and window frame.

Even further, in this context the term “mechanical connection means” should be understood as any kind mechanical connector capable of mechanically connecting the connecting strip to the window frame—i.e. the term includes any kind of screws, bolts, rivets or other.

In an aspect of the invention, the mechanical connection means are screws or bolts.

Screws and bolts are simple, inexpensive and well-proven means for connecting materials having different coefficient of thermal expansion and screws and bolts are therefore particularly suited for connecting the connecting strip to the window frame of a window assembly according to the present invention.

In an aspect of the invention, the connecting strip is made from a composite material comprising between 20% and 95% glass fiber by weight and preferably between 40% and 80% glass fiber by weight.

If the connecting strip comprises too much glass fiber material, it becomes to brittle and too difficult to manufacture and machine. However, if the connecting strip comprises too little glass fiber material, the coefficient of thermal expansion and other qualities of the connecting strip becomes to remote from the coefficient of thermal expansion and other qualities of the windowpane, and it becomes more difficult to form strong adhesion between the connecting strip and the windowpane. Thus, the present glass fiber content ranges of the composite material forming the connecting strip present an advantageous relationship between the ability to make the connecting strip and the possibility of forming strong adhesion against the windowpane.

In an aspect of the invention, the connecting strip comprises a glass fiber reinforced polymer.

Forming the connecting strip of glass fiber reinforced polymer is advantageous in that the glass fiber will make the connecting strip strong while at the same time ensuring that the coefficient of thermal expansion of the connecting strip becomes more similar to the coefficient of thermal expansion of the windowpane made of glass. And by binding the glass fiber in a polymer matrix it is possible to form a strong and durable material that can be machined.

In an aspect of the invention, the polymer comprises polyester, polyurethane, or epoxy resin.

Polyester, polyurethane, and epoxy are inexpensive and strong polymers particularly suited for binding the glass fiber in a connecting strip.

In an aspect of the invention, the connecting strip is formed by pultrusion.

Forming the connecting strip by means of pultrusion is advantageous in that pultrusion is a simple way of forming fiber reinforced materials suited as a connecting strip for a window assembly.

In this context the term “Pultrusion” should be understood as the is the continuous process for manufacture of fiber-reinforced plastics with constant cross-section. As opposed to extrusion, which pushes the material, pultrusion pulls the material.

In an aspect of the invention, the connecting strip comprises an adhesive trench extending along a window side of the connecting strip facing the windowpane.

Forming an adhesive trench in the side of the connecting strip facing the windowpane is advantageous in that such an adhesive trench will enable that it is possible to form a relatively thick layer of adhesive more easily between the windowpane and the connecting strip while enabling that the adhesive is not visible.

In an aspect of the invention, the through-holes are countersunk.

Countersinking the through-holes is advantageous in that it hereby is possible to embed the head of the mechanical connection means—such as screws or bolts—in the connecting strip and thereby enable a more compact strip—thereby reducing cost and space consumption.

In an aspect of the invention, the connecting strip is extending between 0.5 and 80 mm, preferably between 1 and 40 mm and most preferred between 2 and 20 mm from the windowpane in a direction towards the window frame.

The connecting strip is typically made from a more problematic and/or expensive material and if the connecting strip is extending too far from the windowpane towards the window frame the environmental impact and/or the cost of the window assembly is increased. However, if the connecting strip is extending too little from the windowpane, the connecting strip is not strong enough to transfer the forced between the windowpane and the window frame. Thus, the present size ranges present an advantageous relationship between cost/environmental issues and functionality.

In an aspect of the invention, the connecting strip has a strip coefficient of thermal expansion, wherein a glass panel of the windowpane has a glass coefficient of thermal expansion and wherein the difference between the strip coefficient of thermal expansion and the glass coefficient of thermal expansion is less than 80%, preferably less than 60% and most preferred less than 40%.

The closer the coefficient of thermal expansion of the connecting strip is to the coefficient of thermal expansion of the windowpane—i.e., glass—the more uniformly the connecting strip and the windowpane will expand and contract in varying temperatures. Thus, it is advantageous that the strip coefficient of thermal expansion of the connecting strip is as close to the glass coefficient of thermal expansion of the glass part of the windowpane as possible while at the same time ensuring that connecting strip is not to weak or brittle that it is not able to transfer torque between the windowpane and the window frame.

In an aspect of the invention, the windowpane is at least double-glazed to form insulated glazing of the window assembly.

Modern windows have to be at least double-glazed to reduce heat loss through the pane and thereby create an insulating effect and providing the window assembly with at least double-glazing the window assembly will provide better insulation through reduced heat transfer through the windowpane.

Insulated glazing (IG)—also known as Insulated Glass Unit (IGU)—is more commonly known as double-glazing (or double-pane, and increasingly triple glazing/pane or even more layers). An IGU consists of two or three transparent glass plates separated by a vacuum or gas filled space primarily to reduce heat transfer across the windowpane.

In an aspect of the invention, the windowpane is self-supporting.

Forming the windowpane self-supporting e.g., by making the windowpane of hardened or laminated glass panels and/or by connecting the glass panels of the windowpane by means of strong adhesive or other is advantageous in that no addition support structure is needed and it is thereby possible to form an all-glass exterior of the window by only connecting the connecting strip and the window frame to the inside surface of the windowpane.

In this context the term “self-supporting” should be understood as the windowpane being able to carry its own weight—even if the windowpane is double or triple glazed—without the need of additional frames, sash or support structures surrounding the entire outer edge as with traditional windows.

In an aspect of the invention, the window frame comprises wood.

Wood is inexpensive, environmentally friendly, and easy to machine and have therefore been used as a building material for a long time. It is therefore advantageous to make the window frame of wood.

In an aspect of the invention, the window frame comprises window connection means enabling that the window assembly can be connected to a surrounding structure.

Making the window frame comprises window connection means aiding in connecting the window assembly to a surrounding structure is advantageous in that the window frame is easily accessible.

Note that in this context the term “window connection means” should be understood as any kind connector capable of enabling connection of the window frame of the window assembly to the surrounding structure—i.e. to a building, a neighboring window assembly or other. I.e., the term includes any kind of screws, bolts, interlocking geometry, pins, brackets, through holes, fittings or other.

In an aspect of the invention, the part of the connecting strip that is visible between the windowpane and the window frame is between 0.5 and 20 mm, preferably between 1 and 15 mm and most preferred between 2 and 12 mm.

If too much of the connecting strip is visible between the windowpane and the window frame the connecting strip will become too costly and bulky. However, if too little of the connecting strip is visible between the windowpane and the window frame, condensed water gathering at the bottom of the windowpane will more easily come in contact with the window frame and potentially damage the window frame. Thus, the present size ranges present an advantageous relationship between cost and functionally.

In an aspect of the invention, the adhesive is an electrically conductive adhesive.

Using electrically conductive adhesive for connecting the connecting strip to the windowpane is advantageous in that it is hereby possible to heat the adhesive by establishing an electrical current through the adhesive-thereby reducing the curing time of the adhesive or soften cured adhesive to enable separation of the connecting strip from the windowpane e.g., at demolishing or if the windowpane needed to be replaced.

In an aspect of the invention, the window assembly further comprises an electrical current conductor arranged between the windowpane and the connecting strip.

Arranging an electrical current conductor between the windowpane and the connecting strip is advantageous in that it is hereby possible to heat the adhesive by establishing an electrical current through the electrical current conductor-thereby reducing the curing time of the adhesive or soften cured adhesive to enable separation of the connecting strip from the windowpane e.g., at demolishing or if the windowpane needed to be replaced.

In an aspect of the invention, the electrical current conductor is arranged in a conductor groove formed in the connecting strip.

Arranging the electrical current conductor in a dedicated conductor groove formed in the connecting strip is advantageous in that the electrical current conductor hereby is better protected and in that the adhesive layer can be formed more uniformly-thereby ensuring better and more reliable adhesion.

In an aspect of the invention, the electrical current conductor is extending substantially the entire length of the connecting strip.

Arranging the electrical current conductor to extend continuously throughout the length of the connecting strip is advantageous in that substantially all the adhesive hereby can be heated by a single electrical current conductor-thereby ensuring a simpler manufacturing and use.

In an aspect of the invention, the electrical current conductor is a metal wire.

Metal is durable and therefore suited for forming an electrical current wire for use in a window assembly.

In an aspect of the invention, the metal is copper or aluminum.

Copper and aluminum are excellent conductors of electrical current and are therefore particularly suited for forming an electrical current conducting wire for use in a window assembly.

In an aspect of the invention, the metal wire has a diameter of between 0.4 and 5 mm, preferably between 0.7 and 3.5 mm and most preferred between 1 and 2 mm.

If the diameter of the metal wire is too big, the electrical current needed to generate sufficient heat will be too high and the wire takes up too much space but if the diameter of the metal wire is too little the risk of the metal wire breaking due to the heat generated or mechanical stress. Thus, the preset diameter ranges provide an advantageous relationship between function and durability.

In an aspect of the invention, ends of the electrical current conductor is arranged to extend out of the connecting strip.

Making the electrical current conductor extend out of the connecting strip e.g., to an outer surface of the window assembly is advantageous in that it hereby is easier to connect an electrical current generating device to the electrical current conductor.

The invention further relates to a method for assembling a window assembly. The method comprises the steps of:
forming through-holes in a connecting strip,
connecting the connecting strip to a window frame by means of mechanical connection means extending through the through-holes, and
adhering the connecting strip to a windowpane along a periphery of one side of the windowpane by means of an adhesive.

Connecting the connecting strip to one side of the windowpane by means of adhesion is advantageous in that this enables that the other side of the windowpane is frameless and all-glass—i.e., no thermal bridges, frame maintenance etc.—while at the same time ensuring that a strong adhesion can be formed because the coefficient of thermal expansion of the connecting strip and the windowpane can be more similar. And connecting the connecting strip to the window frame by means of mechanical connection means is advantageous in that the window frame hereby can be made in a material that is more inexpensive, more environmentally friendly, easier to machine or other-thereby enabling a better and/or cheaper window assembly.

Connecting the connecting strip to the window frame by making the mechanical connection means extend through through-holes in the connecting strip is a simple and inexpensive way of forming a strong joint.

In an aspect of the invention, the method further comprises the step of forming an adhesive trench along a window side of the connecting strip and adhering the connecting strip to the windowpane so that the window side is facing the windowpane and so that the adhesive is arranged in the adhesive trench.

Producing the window assembly so that the adhesive is arranged in an adhesive trench in the connecting strip is advantageous in that it hereby simplifies production and makes it easier to form a strong adhesion.

In an aspect of the invention, the method further comprises the step of pre-drilling blind holes in the window frame before connecting the connecting strip to the window frame, wherein the connecting strip is connected to the window frame by means of the mechanical connection means extending into the pre-drilled blind holes.

Connecting the connecting strip to the window frame by making the mechanical connection means extend into pre-drilled blind holes in the window frame is a simple and inexpensive of forming a strong joint. Furthermore, pre-drilling blind holes reduces the risk of the window frame splitting when the mechanical connection means are fitted.

In an aspect of the invention, the method further comprises the step of arranging an electrical current conductor between the windowpane and the connecting strip.

Arranging an electrical current conductor between the windowpane and the connecting strip is advantageous in that it is hereby possible to heat the adhesive by establishing an electrical current through the electrical current conductor-thereby reducing the curing time of the adhesive or soften cured adhesive to enable separation of the connecting strip from the windowpane e.g., at demolishing or if the windowpane needed to be replaced.

In an aspect of the invention, the method further comprises the step of heating the electrical current conductor by generating an electrical current in the electrical current conductor.

Heating the electrical current conductor is advantageous in that it hereby is possible to expedite the curing process of the adhesive thereby reducing manufacturing time. Furthermore, heating the electrical current conductor can also be used for softening cured adhesive in a subsequent separation process.

In an aspect of the invention, the method is for assembling a window assembly according to any of the previously discussed window assemblies.

Hereby is achieved an advantageous embodiment of the invention.

Further the invention relates to use of a window assembly according to any of the previously discussed window assemblies as a window in a building, wherein the window assembly is connected to the building through the window frame.

Using the window assembly according to the present invention as a window in a building and connecting the window assembly the building through the window frame is advantageous in that the window frame is easily accessible from the inside of the building, thus ensuring that the window assembly is easy to mount and ensuring that the means connecting the window frame to the building is better protected.

### FIGURES

The invention will be described in the following with reference to the figures in which

FIG. 1 illustrates a window assembly, as seen from the back,

FIG. 2 illustrates a cross section through the middle of a window assembly, as seen from the side,

FIG. 3 illustrates a cross section through a cutout section of a first embodiment of a window assembly, as seen from the side,

FIG. 4 illustrates a cross section through a cutout section of a second embodiment of a window assembly, as seen from the side,

FIG. 5 illustrates a cross section through a cutout section of a third embodiment of a window assembly, as seen from the side, and

FIG. 6 illustrates a cross section through a cutout section of a fourth embodiment of a window assembly, as seen from the side.

### DETAILED DESCRIPTION

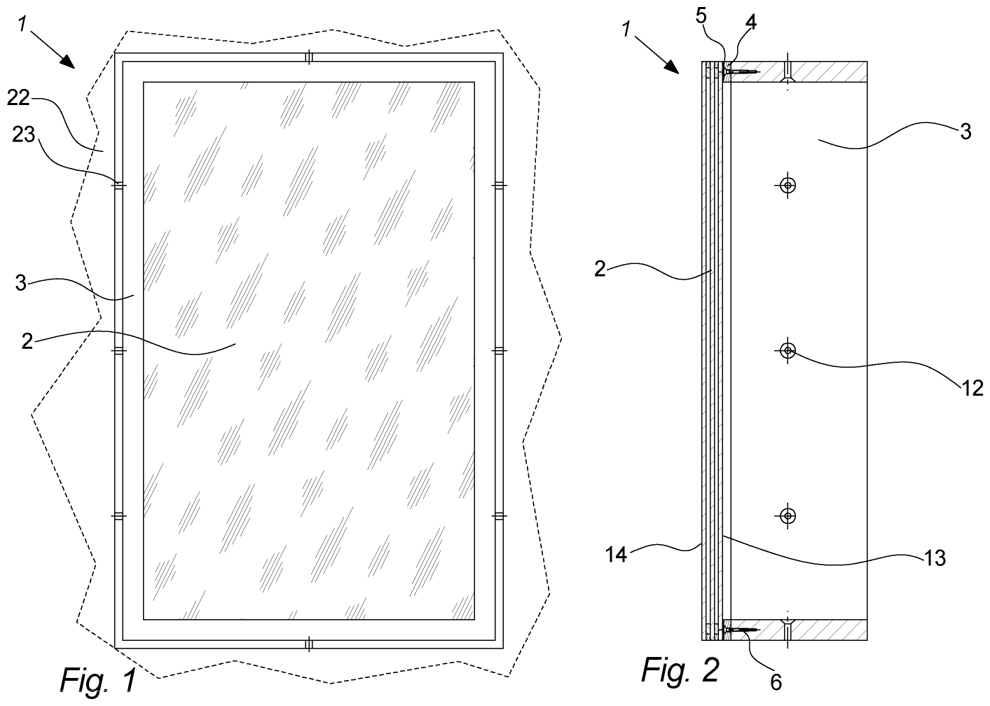

FIG. 1 illustrates a window assembly 1, as seen from the back—i.e. as seen from the inside of a building in which the window assembly 1 is mounted—and FIG. 2 illustrates a cross section through the middle of a window assembly 1, as seen from the side.

In this embodiment the window assembly 1 comprises a windowpane 2 adhered to a connecting strip 4 by means of an adhesive 5 and the connecting strip 4 is further connected to a window frame 3 by means of mechanical connection means 6 in the form of screws, so that the connecting strip 4 is bridging and transferring torque between the windowpane 2 and the window frame 3 as will be discussed in more details in relation to the following figures. However, in another embodiment the mechanical connection means 6 could instead or also comprise bolts, rivets locking pins or other.

In this embodiment the connecting strip 4—and thereby the window frame 3—are connected to the windowpane 2 all along the periphery of the inside surface 13 of the windowpane 2. Thus, in this embodiment the outside surface 14 of the windowpane 2 is all-glass and frameless. In another embodiment the connecting strip 4 and/or the window frame 3 would only extend along parts of the periphery of the inside surface of the windowpane 2.

In this embodiment the window frame 3 comprises window connection means 12 in the form of through holes arranged to facilitate frame screws 23 so that the window frame 3 may be connected to a surrounding structure—such as a building 22—by aid of these window connection means 12.

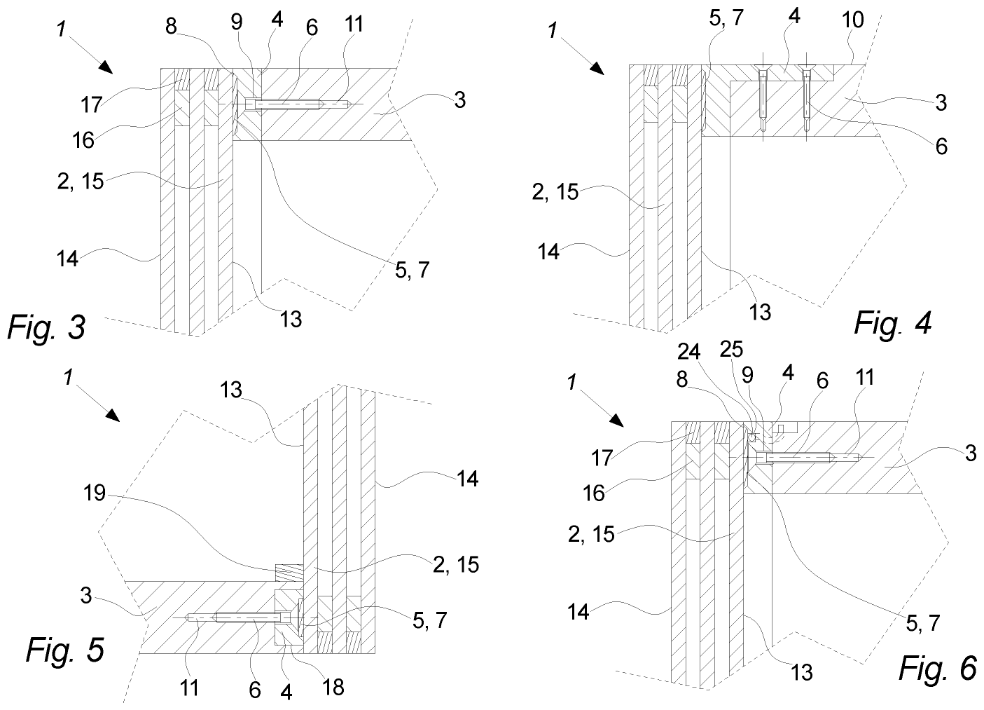

FIG. 3 illustrates a cross section through a cutout section of a first embodiment of a window assembly 1, as seen from the side.

In this embodiment the window assembly 1 is assembled by first connecting the connecting strip 4 to the window frame 3 by means of the mechanical connection means 6, and then adhering the connecting strip 4 to the windowpane 2 along a periphery of one side of the windowpane 2 by means of adhesive 5. However, in another embodiment the connecting strip 4 could be adhered to the windowpane 2 first and then the connecting strip 4 is connected to the window frame 3 by means of mechanical connection means 6.

In this embodiment an adhesive trench 7 is first formed along a window side 8—i.e. the side of the connecting strip 4 facing the windowpane 2—of the connecting strip 4, before the connecting strip 4 is adhered to the windowpane 2. The adhesive trench 7 ensures that the adhesive 5 is forming an evenly thick layer ensuring a strong bond. In this embodiment the adhesive trench 7 is extending the entire length of the longitudinal extent of the connecting strip 4 but in another embodiment the adhesive trench 7 would only extend parts of the longitudinal extent of the connecting strip 4 and/or the connecting strip 4 could comprise more than one adhesive trench 7. In another embodiment the adhesive trench 7 could also or instead comprise indentations, transverse grooves or other.

In this embodiment the adhesive 5 is as high strength two-component epoxy adhesive but in another embodiment the adhesive 5 could also or instead comprise Polyurethane adhesive, acrylic adhesive or other.

In this embodiment the windowpane 2 is triple-glazed—i.e., the windowpane 2 comprises three panels 15 of glass in-between which a gas filled enclosure is formed to reduce the thermal conductivity of the pane 2. However, in another embodiment the windowpane 2 could comprise more layers such as four, five or even more or the windowpane 2 could comprise less layers such as two or even only a single layer.

In this embodiment the glass panels 15 of the windowpane 2 are spaced apart by a spacer moulding 16 typically made from stainless steel or aluminum and the panels 15 are connected by means of a panel adhesive 17 between the panels 15 along the outer edge of the windowpane 2. In this embodiment the panel adhesive 17 is an UV—resistant silicone adhesive but in another embodiment the panel adhesive 17 could also or instead be an epoxy adhesive, a Polyurethane adhesive, an acrylic adhesive or other. Thus, because of the glass panels 15 of the windowpane 2 are interconnected to form a sandwich structure, the windowpane 2 is in this embodiment self-supporting—i.e. in this embodiment glass panels 15 of the windowpane 2 will not break apart even if the weight of the entire windowpane 2 is carried by the connecting strip 4 adhered to the inside surface 13 of the windowpane 2.

In this embodiment the window frame 3 is made entirely of wood and to reduce the risk of the window frame 3 splitting when connecting strip 4 is connected to the window frame 3 by means of the mechanical connection means 6 blind holes 11 are first pre-drilled in the window frame 3.

And in this embodiment through holes 9 are first formed in the connecting strip 4 before connecting strip 4 is connected to the window frame 3 by means of the mechanical connection means 6. In this embodiment the through holes 9 are countersunk to accommodate the head of the mechanical connection means 6 but, in another embodiment the through holes 9 would not be countersunk.

In this embodiment the connecting strip 4 is made from a composite material in the form of glass fiber reinforced polyester and in this embodiment the composite material comprises around 60% glass fiber by weight. However, in another embodiment the composite material could comprise less glass fiber—such as only 50%, 35% or even less—or the composite material could comprise more glass fiber—such as 70%, 85% or even more. Also, in another embodiment the matrix fixating the glass fiber could also or instead comprise vinyl ester, phenols, polyvinyl chloride, acrylonitrile butadiene styrene, thermoplastics, thermoset plastics and/or other.

In this embodiment the connecting strip 4 has a strip coefficient of thermal expansion of 12×10⁻⁶ K⁻¹ while the glass panel 15 of the windowpane 2 to which the connecting strip 4 is adhered has a glass coefficient of thermal expansion of around 9×10⁻⁶ K⁻¹ Thus, in the embodiment the difference between the strip coefficient of thermal expansion and the glass coefficient of thermal expansion is around 30% however in another embodiment the difference between the strip coefficient of thermal expansion and the glass coefficient of thermal expansion could be less—such as 25%, 20% or even smaller—or the difference could be grater—such as 35%, 55% or even more.

In this embodiment the connecting strip 4 is made by pultrusion but in another embodiment the connecting strip 4 could also or instead be made by lamination, moulding or other.

In this embodiment the connecting strip 4 is approximately 18 mm thick i.e., in this embodiment the connecting strip 4 is extending around 18 mm from the windowpane 2 in the direction towards the window frame 3. However, in another embodiment the connecting strip 4 could be thinner—such as 16 mm, 12 mm, 8 mm or even thinner—or the connecting strip 4 could be thicker—such as 25 mm, 35 mm, 45 mm or even thicker.

Since the connecting strip 4 in this embodiment is as wide as the window frame 3 the entire extent of the connecting strip 4 from the windowpane 2 to the window frame 3 is visible but in another embodiment parts of the connecting strip 4 could be embedded in the window frame 3 so that only a part of the extent of the connecting strip 4 from the windowpane 2 and in the direction of the window frame 3 would be visible. I.e. in another embodiment only 3 mm, 5 mm, 8 mm of the connecting strip 4 would be visible even if the connecting strip 4 is extending more from the windowpane 2 in the direction towards the window frame 3.

In this embodiment the window frame 3 is entirely made of oak wood but in another embodiment the window frame 3 could entirely or partly be made of another type of wood—such as pine, ash, birch, mahogany or other—or the window frame 3 could also or instead comprise other materials such as compress reinforced cardboard, plastic, metal or other.

FIG. 4 illustrates a cross section through a cutout section of a second embodiment of a window assembly 1, as seen from the side.

In this embodiment a part of the connecting strip 4 is formed to extend along a part of the outer surface 10 of the window frame 3 thus making the mechanical connection means 6 accessible even after the window assembly is fully assembled—without being visible from inside the window frame 3—and enabling that the connecting strip 4 can be adhered to the windowpane 2 before the window frame 3 is connected to the connecting strip 4 by means of the mechanical connection means 6.

FIG. 5 illustrates a cross section through a cutout section of a third embodiment of a window assembly 1, as seen from the side.

In this embodiment the end of the window frame 3 is provided with a strip grove 18 in which the connecting strip 4 is placed so that parts of the window frame 3 are substantially abutting the windowpane 2. To protect the window frame 3 from condensed water gathering at the bottom of the inside of the windowpane 2, the window assembly 1 is in this embodiment also provide with a rubber strip 19 along the inside corner between the windowpane 2 and the window frame 3. However, if the window frame 3 was made of a material that would not be damaged by water, the rubber strip 19 could be omitted.

FIG. 6 illustrates a cross section through a cutout section of a fourth embodiment of a window assembly 1, as seen from the side.

In this embodiment the window assembly 1 is provided with an electrical current conductor 24 arranged to run continuously around the periphery of the windowpane 2 with the connecting strip 4 close to the adhesive 5 so that the two ends of the continuous electrical current conductor 24 are arranged next to each other. However, in another embodiment the window assembly 1 could comprise more than one electrical current conductor 24 either running side by side or arranged in continuation of each other.

In this embodiment the electrical current conductor 24 is arranged is a conductor groove 25 formed in the connecting strip 4 in the bottom of the adhesive trench 7 but in another embodiment the electrical current conductor 24 could also or instead be placed in the adhesive trench 7, in a conductor channel (not shown) separated from the adhesive trench 7, it could be embedded in the connecting strip 4, placed directly between the windowpane 2 and the connecting strip 4 and/or in another place.

In this embodiment the electrical current conductor 24 is a single copper wire but in another embodiment the electrical current conductor 24 could be made from another electrical current conducting material—such as aluminum, silver, carbon or other or any combination thereof—and/or the electrical current conductor 24 could be formed as a separate strip, a rod or other and/or the electrical current conductor 24 could form part of a surface of the connecting strip 4 e.g., through etching.

In this embodiment the electrical current conductor 24 is provided to reduce the curing time of the adhesive 5 to thereby reduce manufacturing time and it is provided to soften the cured adhesive, if the connecting strip 4 ever subsequently needs to be removed from the windowpane 2. This is done by connecting an electrical current generating device (not shown)—such as a battery, a transformer, a generator or other to the ends of the electrical current conductor 24 to generate a flow of electrical current trough the electrical current conductor 24 which in turn will heat it up. The heat will expedite curing of the adhesive 5 and by controlling the current, the speed of the curing of the adhesive can be controlled while it at the same time can be ensured that the adhesive (or other parts of the window assembly 1) is not heated so much that it is damaged.

To enable easy access to the ends of the electrical current conductor 24 the ends of the electrical current conductor 24 are in this embodiment guided out into a small cavity in the outside surface of the window frame 3. When the ends are not connected to the electrical current generating device (not shown) the cavity could be sealed by means of a lid, a cover plate or other. However, in another embodiment the ends of the electrical current conductor 24 could be located elsewhere—e.g., embedded in the window assembly 1 after assembly, in a cavity in the connecting strip 4 and/or the ends of the electrical current conductor 24 could be connected to a plug or socket located on the window assembly 1.

In this embodiment the electrical current conductor 24 has a diameter of 1.5 mm to ensure that it does not break too easily, to ensure that it can allow sufficient current flow to generate the necessary heat and to ensure that it does not take up too much space. However, in another embodiment the electrical current conductor 24 could be thinner—such as 1.2 mm, 0.9 mm, 0.6 mm or even thinner—or it could be thicker—such as 1.7 mm, 2.1 mm, 2.7 mm or even thicker—e.g., depending on the location of the electrical current conductor 24, the material forming the electrical current conductor 24, the number of electrical current conductors 24, the specific adhesive 5, the specific connecting strip 4 or other.

It should be noticed that any orientation reference made throughout this application—such as top, bottom, upper, lower, up, down, side, inside, outside etc.—in made is relation to the window assembly 1 when mounted as intended in a building surface—i.e., when the window assembly 1 is mounted with its normal and intended orientation and is in use as a window in a building surface.

The invention has been exemplified above with reference to specific examples of window assemblies 1, windowpanes 2, window frames 3 and other. However, it should be understood that the invention is not limited to the particular examples described above but may be designed and altered in a multitude of varieties within the scope of the invention as specified in the claims.

### LIST

1. Window assembly
2. Windowpane
3. Window frame
4. Connecting strip
5. Adhesive
6. Mechanical connection means
7. Adhesive trench
8. Window side of connecting strip
9. Through-hole in connecting strip
10. Outer surface of window frame
11. Pre-drilled blind hole in window frame
12. Window connection means
13. Inside surface of the windowpane
14. Outside surface of windowpane
15. Glass panel
16. Spacer moulding
17. Panel adhesive
18. Strip groove
19. Rubber strip
20. Dovetail track
21. Dovetail protrusion
22. Building
23. Frame screw
24. Electrical current conductor
25. Conductor groove

1-30. (canceled)

31. A window assembly comprising:
a windowpane,
a window frame extending along a periphery of one side of said windowpane, and
a connecting strip arranged between said window frame and said windowpane,
wherein said connecting strip is adhered to said windowpane by way of an adhesive and said connecting strip is connected to said window frame by way of mechanical connectors extending through through-holes in said connecting strip.

32. The window assembly according to claim 31, wherein said mechanical connectors are screws or bolts.

33. The window assembly according to claim 31, wherein said connecting strip is made from a composite material comprising between 20% and 95% glass fiber by weight and preferably between 40% and 80% glass fiber by weight.

34. The window assembly according to according to claim 31, wherein said connecting strip comprises a glass fiber reinforced polymer.

35. The window assembly according to according to claim 34, wherein said polymer comprises polyester, polyurethane, or epoxy resin.

36. The window assembly according to claim 31, wherein said connecting strip comprises an adhesive trench extending along a window side of said connecting strip facing said windowpane.

37. The window assembly according to claim 31, wherein said connecting strip is extending between 0.5 and 80 mm, preferably between 1 and 40 mm and most preferred between 2 and 20 mm from said windowpane in a direction towards said window frame.

38. The window assembly according to claim 31, wherein said connecting strip has a strip coefficient of thermal expansion, wherein a glass panel of said windowpane has a glass coefficient of thermal expansion and wherein the difference between said strip coefficient of thermal expansion and said glass coefficient of thermal expansion is less than 80%, preferably less than 60% and most preferred less than 40%.

39. The window assembly according to claim 31, wherein said windowpane is at least double-glazed to form insulated glazing of said window assembly.

40. The window assembly according to claim 31, wherein said windowpane is self-supporting.

41. The window assembly according to claim 31, wherein said window frame comprises wood.

42. The window assembly according to claim 31, wherein the part of said connecting strip that is visible between said windowpane and said window frame is between 0.5 and 20 mm, preferably between 1 and 15 mm and most preferred between 2 and 12 mm.

43. The window assembly according to claim 31, wherein said adhesive is an electrically conductive adhesive.

44. The window assembly according to claim 31, wherein said window assembly further comprises an electrical current conductor arranged between said windowpane and said connecting strip.

45. The window assembly according to claim 44, wherein said electrical current conductor is arranged in a conductor groove formed in said connecting strip.

46. The window assembly according to claim 44, wherein said electrical current conductor is extending substantially the entire length of said connecting strip.

47. The window assembly according to claim 44, wherein ends of said electrical current conductor is arranged to extend out of said connecting strip.

48. The method for assembling a window assembly, said method comprising the steps of:
forming through-holes in a connecting strip,
connecting said connecting strip to a window frame by way of mechanical connectors extending through said through-holes, and
adhering said connecting strip to a windowpane along a periphery of one side of said windowpane by way of an adhesive.

49. The method according to claim 48, wherein said method further comprises the step of arranging an electrical current conductor between said windowpane and said connecting strip, and wherein said method further comprises the step of heating said electrical current conductor by generating an electrical current in said electrical current conductor.

50. Use of a window assembly according to claim 31 as a window in a building, wherein said window assembly is connected to said building through said window frame.
